(19) United States
(12) Patent Application Publication
(10) Pub. No.: US 2009/0045133 A1
(43) Pub. Date: Feb. 19, 2009

(54) Low Pressure Drop Cyst Filter

(76) Inventors: Jessica E. Waterhouse, Nottingham, NH (US); Derek M. Rowley, Dover, NH (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/839,223

(22) Filed: Aug. 15, 2007

(51) Int. Cl. B01D 39/00; B05D 1/00

(52) U.S. Cl. 210/500.21; 427/206

(57) ABSTRACT

A long life, low pressure drop, cyst reduction water filter includes two active layers, the first comprising a non-woven fiber layer of nominal submicron porosity that retains cysts, but provides a good flow rate, and an upstream protective layer of a different non-woven fiber layer that captures particulates which would otherwise overwhelm and plug the cyst reduction layer.

### BACKGROUND OF THE INVENTION

The present invention relates to filters for purifying drinking water and, more particularly, to a multi-layer filter using different fiber media in each layer that removes cysts and provides long life and a low pressure drop.

To qualify for NSF certification for cyst reduction in a drinking water system, a filter must reduce the number of cysts by at least 99.95 percent when tested in accordance with the protocol set forth in NSF Std 53. Porous carbon block filters, comprising carbon particles bonded under pressure, have been made and are available which are capable of meeting the NSF cyst reduction requirements. However, the carbon block structure must be very dense and composed of very small carbon particles to remove cysts. Therefore, the resultant pressure drop across such a porous carbon block filter is typically very high for a given flow rate. Furthermore, high density carbon blocks will tend to filter out all types of particulate matter present in the water with high filtration efficiency. This results in premature plugging and more frequent filter changes. The primary problem, as identified above, is high pressure drop and low flow rate.

Cyst capable filters have also been made from single active layer of carbon-filled synthetic fibers deposited on a hollow core. However, in order to remove cysts, the porosity of these filters is so low that they also suffer the same high pressure drop and low flow rate of filters made of carbon particles.

### SUMMARY OF THE INVENTION

In accordance with one aspect of the subject invention a long life, low pressure drop, cyst reduction water filter comprises at least two fiber layers, each having distinctly different fiber make-ups, that are formed on a rigid foraminous cylindrical core. The fiber layers include a first active fiber layer on the core, the fibers having diameters in the range of about 0.5 to 5.0 μm and having fiber lengths in the range of about 0.3 to 1.0 mm, and a binder. The second active fiber layer overlies and covers the first active layer and has fiber diameters in the range of about 5 to 45 μm and fiber lengths in the range of about 1 to 7 mm, and a binder.

Preferably, the first active layer fibers comprise glass fibers. However, the first active layer may also include synthetic fibers. If used, the synthetic fibers may have a diameter of about 5 μm and a length of about 1 mm. One preferable form of the synthetic fibers is polyethylene. Synthetic fibers are preferable for use in the second active layer. The fibers may comprise a mix of polyolefin and acrylic fibers. Preferably, a post-filtration synthetic fiber layer is interposed between the core and the first active fiber layer. The fibers in the post-filtration layer may have diameters in the range of about 5 to 40 μm and lengths in the range of about 1 to 7 mm. The synthetic fibers for the post-filtration layer are selected from the group comprising polyethylene, polypropylene and mixtures thereof.

The first and second active layers are preferably deposited on the core from an aqueous slurry of fibers and, most preferably, by the use of a vacuum deposition process. In accordance with the method of the present invention, a first active filter layer is deposited on rigid foraminous core from an aqueous slurry of fibers having diameters in the range of about 0.5 to 5.0 μm and fiber lengths in the range of about 0.3 to 1.0 mm, and a binder. The second active layer is deposited on the first active layer from an aqueous slurry of fibers having fiber diameters in the range of about 5 to 45 μm and lengths in the range of about 1 to 7 mm, and a binder. Preferably, before the step of depositing the first active layer, the method includes the step of depositing on the core a post-filtration layer from an aqueous slurry of fibers having diameters of about 5 to 40 μm and fiber lengths in the range of about 1 to 7 mm, and the modified step of depositing the first active layer on the post-filtration layer. The depositing steps preferably comprise vacuum depositing. The method also includes the step of curing the filter by heating to remove moisture and to set the binder.

In a preferred embodiment of the present invention, a long life, low pressure drop, cyst reduction water filter includes a rigid porous cylindrical core, a first active fiber layer that is deposited on the core, the fibers having diameters in the range of about 0.5 to 5 μm and having varying lengths in the range of about 0.3 to 1 mm, and a binder. The first layer has a nominal porosity of about 0.5 μm. A second active fiber layer is deposited on the first layer, the fibers of the second layer having diameters in the range of about 5 to 45 μm and having varying lengths in the range of about 1 to 7 mm, and a binder. The second active layer has a nominal porosity in the range of about 1 to 30 μm. The filter is enclosed in a housing adapted to receive water to be filtered and to direct the water radially through the second layer, the first layer and the core. Preferably, the filter includes a post-filtration fiber layer that is deposited on the core before the first active layer. The post-filtration layer includes fibers having diameters in the range of about 5 to 35 μm and having varying lengths in the range of about 1 to 7 μm. The post-filtration layer has a nominal porosity in the range of about 5 to 15 μm.

The fibers are selected from the group consisting of glass fibers, synthetic fibers and cellulose fibers. The first active layer fibers preferably comprise primarily glass fibers. The first active layer fibers may also comprise synthetic fibers. In a preferred construction the glass fibers comprise 90 wt. % and the synthetic fibers 10 wt. %. Preferably, the glass fibers comprise 65 wt. % fibers having a diameter of 0.6 μm and 25 wt. % glass fibers having a diameter of 2.6 μm,

The second active layer fibers preferably comprise synthetic fibers and, more preferably, a mixture of polyethylene fibers, acrylic fibers and polypropylene fibers.

The post-filtration layer fibers preferably comprise synthetic fibers and, more preferably, polyolefin fibers, such as polyethylene and polypropylene.

In another embodiment, a long life, low pressure drop, cyst reduction water filter includes a rigid foraminous cylindrical core, a first active layer that is deposited on the core from an aqueous flurry of fibers having fiber diameters in the range of about 0.5 to 5.0 μm and fiber lengths in the range of about 0.3 to 1.0 mm, and a binder. The filter includes a second active layer deposited on the first active layer from an aqueous slurry of fibers having fiber diameters in the range of about 5 to 45 μm and fiber lengths in the range of about 1 to 7 mm, and a binder.

First and second active layers are preferably vacuum deposited. Fibers in the first active layer preferably comprise glass fibers. Glass fibers have diameters in the range of 0.6 to 2.6 μm. Glass fibers have a length in the range of about 0.3 to 0.5 mm. Preferably, a post-filtration layer is vacuum deposited on the core before the first active layer from an aqueous slurry of fibers having diameters of not less than about 5 micron, and a binder. The post-filtration layer of fibers are preferably selected from the group consisting of synthetics and cellulose. In one preferred embodiment, the fibers of the post-filtration layer comprise a polyolefin.

The first active layer may include synthetic or cellulose fibers. The binder in the first active layer comprises a polyolefin. The second active layer fibers may comprise synthetics and/or cellulose. The binder also comprises a polyolefin.

In another embodiment of the filter of the present invention, a post-filtration layer is vacuum deposited on a foraminous cylindrical core from an aqueous slurry of synthetic fibers that have nominal diameters in the range of about 5 to 40 μm, and a binder. A first active layer is vacuum deposited on the post-filtration layer from an aqueous slurry of glass and/or synthetic fibers having nominal diameters in the range of about 0.5 to 5 μm, and a binder. The second active layer is vacuum deposited on the first active layer from an aqueous slurry of synthetic fibers having nominal diameters in the range of about 5 to 45 μm, activated carbon particles and a binder. In lieu of or in addition to activated carbon, other powdered adsorbents may be added. Preferably, the first active layer of fibers have a length in the range of about 0.5 to 1.0 mm. The second active layer of fibers preferably have lengths in the range of about 1 to 7 mm. Preferably, the first active layer glass fibers include about 25% fibers having a diameter of 2.5 μm and about 75% fibers having a diameter of 0.6 μm. The post-filtration layer of fibers may have lengths in the range of about 1 to 7 mm.

### BRIEF DESCRIPTION OF THE DRAWINGS

FIG. 1 is a generally schematic axial end view of a filter cartridge made in accordance with the present invention.

FIG. 2 is vertical section taken on line 2-2 of FIG. 1.

FIG. 3 is a graph comparing flow rate and pressure drop in cyst removal capable filters of the prior art and of the present invention in tests performed in accordance with NSF Standard 53.

FIG. 4 is a graph comparing flow rate to inlet pressure in tests using the same filters tested for FIG. 3.

FIG. 5 is a graph comparing flow rate to total volume filtered for some of the same filter cartridges tested in FIGS. 3 and 4 when challenged with one type of fine test dust.

FIG. 6 is a graph comparing flow rate to total volume filtered when using the same filters and test regime as FIG. 5, but challenged with another standard test dust.

### DETAILED DESCRIPTION OF THE PREFERRED EMBODIMENTS

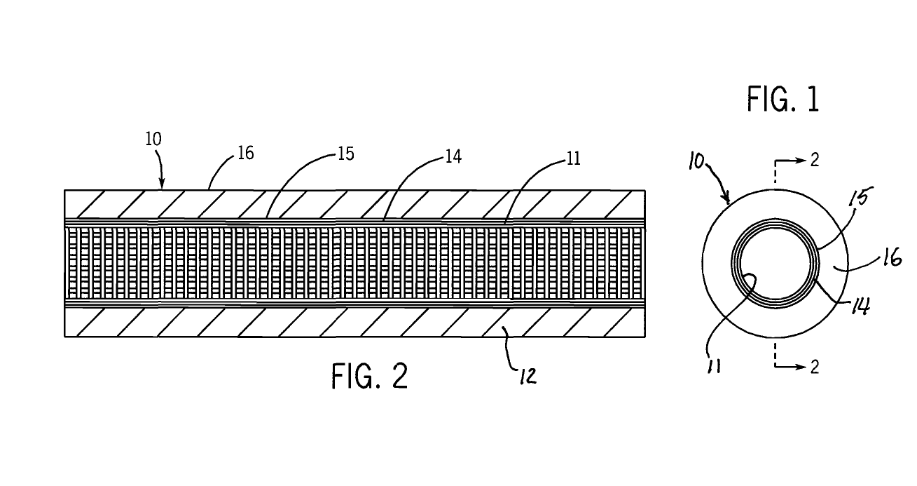

The preferred construction for the cyst reduction water filter 10 of the present invention is shown in FIGS. 1 and 2. The filter includes a rigid foraminous or porous core 11 on which a multi-layer filter body 12 is laid. The core 11 preferably comprises a cylindrical tube 13, the interior of which is completely open or may be supported on its interior by core supports. Thus, the filter 10 is in the form of a conventional cartridge which, in use, is placed in a housing and enclosed with an end cap which directs water into, through and out of the filter 10, all in a manner well known in the art. In particular, inlet water flows radially from the outside, through the multi-layer filter body 12, into the interior of the core tube 13, with the filtered water exiting axially out of one end.

In this preferred embodiment, a post-filtration layer 14 of fine non-woven fibers is first laid on the core 11. A first active fiber layer 15, also comprising a fine non-woven layer, is next laid on the post-filtration layer 14. Finally, a second active layer 16, also of fine non-woven fibers, is laid on the first active layer 15.

The first active layer 15 has cyst removal capability and, as a result, utilizes fibers typically having substantially smaller diameters than the fibers used in the other two layers 14 and 16. The porosity of the first active fiber layer 15 must be low enough to permit cyst retention. The second active fiber layer 16 typically utilizes larger fibers, both in diameter and length, and has a much higher porosity than the first active layer 15. The post-filtration layer 14 is primarily intended to provide a supporting base for the first active layer 15 and also to catch fiber fines that may be dislodged from the first active layer 15 during manufacture or in use.

It has been found that the first active fiber layer 15 can be formed in a manner that provides good cyst removal in full compliance with NSF Standard 53 and, at least initially, good flow rates despite its low porosity. However, other particulates in the feed water, typically larger than cysts, are captured in and eventually overwhelm the first active layer 15, such that pressure drop across the filter layer 15 rapidly increases and adequate flow rates require increasingly higher pressures. The addition of the second active layer 16 permits removal of most of the particulate matter and protects the inner first active cyst layer 15 from plugging. The second active layer may include activated carbon particles for chlorine reduction and other well established uses. In addition, other adsorbents may also be used, such as heavy metal adsorbents for the reduction of lead, arsenic and the like. The result is excellent cyst removal while retaining high flow rate and low pressure drop. Users with low inlet water pressures, who have had difficulty using prior art carbon cyst block filters, can now use the filter of the subject invention to provide good cyst removal at lower system pressures that still provide adequate flow rates.

As indicated above, each of the active filter layers 15 and 16 and the post-filtration layer 14 are made of non-woven fibers. A preferred method for making the filter element 10 comprises vacuum deposition of each of the layers, successively, on the core 11. The core 11 is first immersed in an aqueous slurry of fibers and a polyolefin binder. The vacuum is drawn on the open ID of the core 11 until a layer of fibers of the desired thickness has been laid on the core. For the post-filtration layer 14, a mixture of polyethylene and polypropylene fibers has been found to be suitable, the diameter of the fibers ranging from about 5 to 40 μm and having a length in the range of about 1 to 7 mm. One particularly suitable fiber mixture includes 28 wt. % polyethylene fibers having diameters in the range of 5 to 15 μm and a length of 0.9 mm, and 72 wt. % polypropylene fibers having diameters in the range of about 21 to 34 μm and lengths in the range of about 1 to 6.4 mm. Because the post-filtration layer does not perform an active filtration function, the fibers may be larger than in the active layers, both in terms of diameter and length, and cellulose fibers may be substituted for the synthetic fibers or used in combination therewith. Indeed, it is possible to eliminate the post-filtration layer 14 completely and make the filter 10 by depositing the first active layer 15 directly on the core 11, followed by the second active layer 16. If utilized, the post-filter layer 14 may be up to about 4 mm in thickness and have a nominal porosity in the range of about 5 to 15 μm.

The first active layer 15 is deposited over the post-filtration layer 14 and interior core 11 from an aqueous slurry of fibers and a binder. Glass fibers are particularly preferred for the first active layer 15, primarily because, in the small diameter and length properties that glass can provide, cyst filtration capability has been shown to be best, while retaining good flow properties. However, synthetic fibers, such as polyethylene, may also be included to bulk-up layer 15, thereby improving its flow characteristics without inhibiting cyst reduction. In one particularly suitable formulation, the first active fiber layer 15 comprises a mixture of glass fibers having diameters in the range of about 0.5 to 3.0 μm and a length of about 0.5 mm, and polyethylene fibers having a diameter of about 5 μm and a length of about 1 mm. More specifically, two different glass fibers of different diameters, e.g. 0.6 μm and 2.6 μm, but having about the same length, may be mixed with the indicated polyethylene fibers. A particularly suitable mixture includes 0.6 μm glass fibers at 65 wt. %, 2.6 μm glass fibers at 25 wt. %, and 5 μm polyethylene fibers at 10 wt. %. The respective fiber lengths for the foregoing mixture are 0.46 mm, 0.47 mm and 0.9 mm. This invention also includes the use of all synthetic fibers, with suitably small diameters, in the first active layer.

The second active layer 16 preferably comprises all synthetic fibers. One particularly suitable fiber mixture comprises 27 wt. % polyethylene fibers having a diameter of 15 μm and a length of 0.9 mm, 13% polypropylene fibers having a diameter of 34 μm and a length of 3.2 mm, and 60 wt. % acrylic fibers having diameters in the range of about 5 to 43 μm and a length in the range of 3.2 to 6.5 mm.

The vacuum deposition process used in the preferred method of the present invention provides some beneficial and unexpected characteristics in the active layer that enhance its performance. In a vacuum deposition of the first active layer 15 from a fiber slurry in which the fibers have varying lengths (as indicated in the examples above), there is a tendency under the influence of the vacuum for the smaller or shorter fibers to deposit first on the core or on the post-filter layer 14, if used. The result is a graded density filter layer that enhances overall filtration performance. A similar phenomenon occurs in the formation of the second active layer 16.

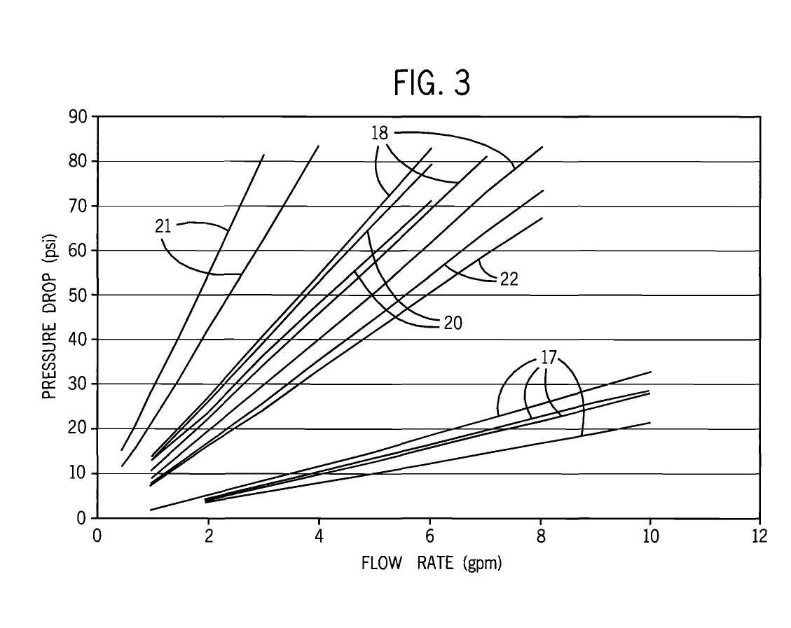

In FIG. 3, the graph shows the results of testing filter elements, all of which have cyst removal capability and are of the same size (10 inches long by 2.6 inches in diameter) to determine the pressure drops across the filters at increasing flow rates. Desirably, the cyst filter should provide a relatively low pressure drop and a flow rate that is adequate for the typical user, who may be a residential user or a food service user.

The four traces numbered 17 are identical 3-layer filters 10 made in accordance with the teachings of the present invention. Traces 18 are from the tests of carbon block cyst filters made by the assignee of the present invention. Traces 20 show the results of two identical filter cartridges, similar to the previously described carbon block elements, obtained from another manufacturer. Similarly, traces 21 are from carbon block cyst filters, similar to those shown in traces 18 and 20, but obtained from yet another manufacturer. Finally, traces 22 show the test results obtained from filter cartridges made from a single active layer vacuum deposition of carbon-filled synthetic fibers with a porosity low enough to remove cysts. The tests for traces 22 place the performance close to that of traces 18 and 20. Most significantly, the filter cartridges of the present invention (traces 17) showed a very good flow rate of 10 gpm at relatively low pressure drops of 20 to 30 psi. The next best test filters, shown in traces 18, could not produce a flow rate above about 8 gpm at pressure drops exceeding 80 psi. This performance is not acceptable for most applications, notwithstanding the ability of all of the tested filters to retain cysts when tested pursuant to NSF Standard 53.

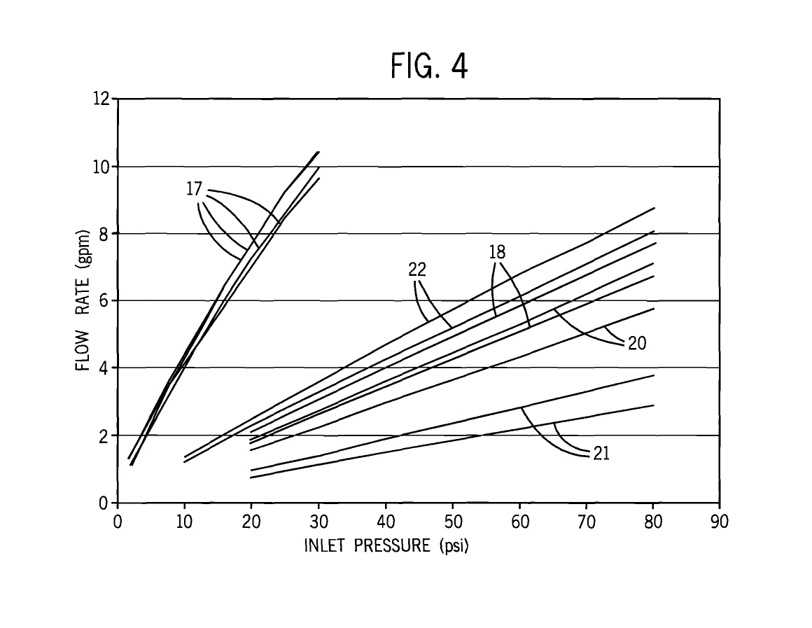

In FIG. 4, flow rates through the same filters tested in FIG. 3 with varying inlet pressures are shown. The traces are numbered identically to those in FIG. 3. Again, the results are quite dramatic in that they clearly show much higher flow rates at very modest inlet pressures for the filters of the present invention (traces 17), as compared to three carbon block cyst filters (traces 18, 20 and 21) and the single layer fiber block filters of traces 22. The filter cartridges of the multi-layer construction of the present invention provided flow rates of about 10 gpm at very modest inlet pressures of about 30 psi. By comparison, the prior art cyst filters provided only about 1 to 3 gpm at 30 psi inlet pressures. The ability of the filters of the present invention to remove cysts at high flow rates and with lower pressure drops permit the use of these filters in applications where prior art carbon block cyst filters were not able to provide sufficient flow or became plugged much too quickly. Alternately, filters of the present invention could be made smaller and more convenient, while still providing cyst removal capability at much higher flow rates.

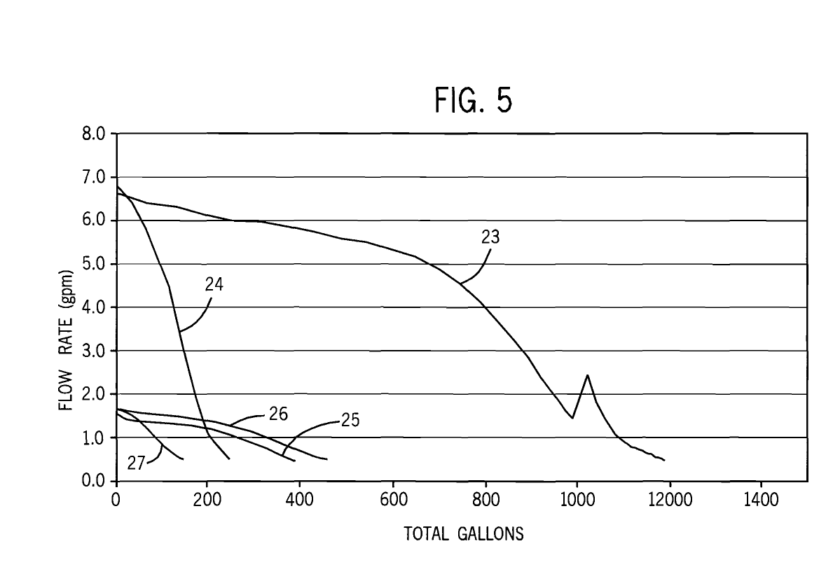

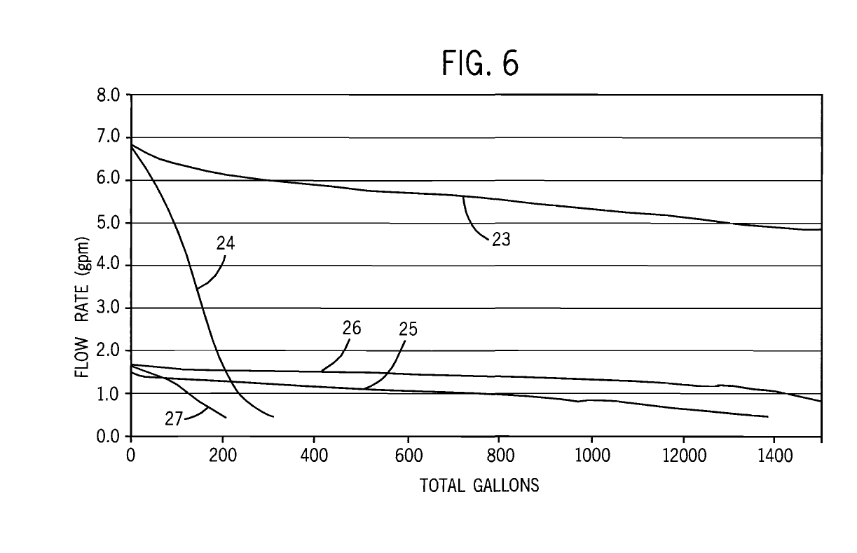

Tests were also run to demonstrate effective filter life, comparing filter cartridges of the present invention with identically sized cartridges of the prior art as well as a modified cartridge of the present invention without the second active layer 16. The graphs of FIGS. 5 and 6 show the results of test in which the feed water was charged with ISO fine test dust (1 to 40 μm) and nominal 0 to 5 μm test dust, respectively. Traces 23 in both FIGS. 5 and 6 show the performance of filters made in accordance with the present invention by comparing the flow rate (gpm) to total gallons filtered at a constant 30 psi influent pressure. Trace 24 shows the results of a modified filter in which the second active layer 16 was eliminated, thus providing a filter element having only the first active layer 15 and post-filtration layer 14. Trace 25 shows the performance of a carbon block cyst filter made by the assignee of the present invention. Trace 26 shows the performance of a single layer synthetic fiber cyst filter cartridge, also made by the assignee of the present invention. Finally, trace 27 shows the performance of a competitive carbon block cyst removal filter element. In addition to confirming the relatively poor performance, in terms of effective filter life, of prior art cyst filters using either carbon particle or carbon fiber blocks, traces 24 show how the performance of the first active layer 15 cartridges of the subject invention is maintained by the protective second active layer 16. The graphs of FIGS. 5 and 6 also show dramatically the ability of filters of the present invention to provide a high flow rate, but to also maintain that flow rate over a significantly longer life than prior art filters. The comparison between traces 23 and 24 demonstrates dramatically how the first and second active layers 15 and 16 of the filter of the present invention work together to prevent plugging and promote a long filter life. This synergistic effect provides an effective cyst filter having a significantly higher flow rate, significantly lower pressure drop and significantly longer effective life than comparable sized cyst removal filters of the prior art.

I claim:

1. A long life, low pressure drop, cyst reduction water filter comprising:
a rigid foraminous cylindrical core;
a first active fiber layer on the core, the fibers having diameters in the range of about 0.5 to 3.0 μm and having filter lengths in the range of about 0.3 to 1.0 mm, and a binder; and,
a second active fiber layer overlying and covering the first active layer and having fiber diameters in the range of about 5 to 45 μm and fiber lengths in the range of about 1 to 7 mm, and a binder.

2. The filter as set forth in claim 1 wherein the first active layer fibers comprise glass fibers.

3. The filter as set forth in claim 2 wherein the first active layer includes synthetic fibers.

4. The filter as set forth in claim 3 wherein the synthetic fibers comprise fibers having a diameter of about 5 μm and a length of about 1 mm.

5. The filter as set forth in claim 4 wherein the synthetic fibers comprise polyethylene.

6. The filter as set forth in claim 1 wherein the second layer fibers comprise synthetic fibers.

7. The filter as set forth in claim 6 wherein the synthetic fibers comprise a mix of polyolefin fibers and acrylic fibers.

8. The filter as set forth in claim 1 including a post-filtration synthetic fiber layer between the core and the first active fiber layer.

9. The filter as set forth in claim 8 wherein the synthetic fibers in the post-filtration layer have fiber diameters in the range of about 5 to 40 μm and lengths in the range of about 1 to 7 mm.

10. The filter as set forth in claim 9 wherein the post-filtration layer fibers are selected from the group consisting of polyethylene, polypropylene and mixtures thereof.

11. A method for making a long life, low pressure drop cyst reduction water filter comprising the steps of:
(1) providing a rigid foraminous cylindrical core;
(2) depositing on the core a first active filter layer from an aqueous slurry of fibers having fiber diameters in the range of about 0.5 to 5.0 μm and having fiber lengths in the range of about 0.3 to 1.0 mm, and a binder; and
(3) depositing on the first active layer a second active layer from an aqueous slurry of fibers having fiber diameters in the range of about 5 to 45 μm and having fiber lengths in the range of about 1 to 7 mm, and a binder.

12. The method as set forth in claim 11 wherein the depositing steps comprise vacuum depositing.

13. The method as set forth in claim 11 including the step of, before depositing the first active layer, depositing on the core a post-filtration layer from an aqueous slurry of fibers having a fiber diameter of about 5 to 40 μm and fiber lengths in the range of about 1 to 7 mm, and a binder; and,
the modified step of depositing the first active layer on the post-filtration layer.

14. The method as set forth in claim 13 including the step of curing the filter by heating to remove moisture and set the binder.

15. A long life, low pressure drop, cyst reduction water filter comprising:
a rigid porous cylindrical core;
a first active filter layer deposited on the core, the fibers having diameters in the range of about 0.5 to 5 μm and having varying lengths in the range of about 0.3 to 1 mm, and a binder, said first layer having a nominal porosity of about 0.5 μm;
a second active fiber layer deposited on the first layer, the fibers having diameters in the range of about 5 to 45 μm and having varying lengths in the range of about 1 to 7 mm, and a binder, said second layer having a nominal porosity in the range of about 1 to 30 μm; and
an enclosing housing for receiving water to be filtered and directing the water radially through the second layer, the first layer and the core.

16. The filter as set forth in claim 15 including a post-filtration fiber layer deposited on the core before the first active layer, said post-filtration layer fibers having diameters in the range of about 5 to 40 μm and having varying lengths in the range of about 1 to 7 μm, said post-filtration layer having a nominal porosity in the range of about 5 to 15 μm.

17. The filter as set forth in claim 16 wherein the post-filtration layer fibers are selected from the group consisting of glass, synthetics and cellulose and mixtures thereof.

18. The filter as set forth in claim 15 wherein the first active layer includes activated carbon.

19. The filter as set forth in claim 15 wherein the first active layer fibers comprise glass fibers.

20. The filter as set forth in claim 19 wherein the first active layer fibers comprise glass fibers and synthetic fibers.

21. The filter as set forth in claim 20 comprising 90 wt. glass fibers and 10 wt. % synthetic fibers.

22. The filter as set forth in claim 21 wherein the glass fibers comprise 65 wt. % glass fibers having a diameter of 0.6 μm and 25 wt. % glass fibers having a diameter of 2.6 μm.

23. The filter as set forth in claim 15 wherein the second active layer fibers comprise synthetic fibers selected from the group consisting of polyolefin fibers and acrylic fibers.

24. The filter as set forth in claim 23 wherein the second active layer fibers comprise polyethylene fibers, acrylic fibers and polypropylene fibers.

25. The filter as set forth in claim 15 wherein the second active fiber layer includes a powdered adsorbent.

26. The filter as set forth in claim 25 wherein the adsorbent comprises activated carbon.

27. The filter as set forth in claim 25 wherein the adsorbent is effective for the removal of heavy metals.

28. The filter as set forth in claim 17 wherein the post-filtration layer fibers comprise synthetic fibers.

29. The filter as set forth in claim 28 wherein the post-filtration layer fibers comprise polyolefin.

30. A long life, low pressure drop, cyst reduction water filter comprising:
a rigid foraminous cylindrical core;
a first active layer deposited on the core from an aqueous slurry of fibers having fiber diameters in the range of about 0.5 to 5.0 μm and fiber lengths in the range of about 0.3 to 1.0 mm, and a binder; and,
a second active layer deposited on the first active layer from an aqueous slurry of fibers having fiber diameters in the range of about 5 to 45 μm and fiber lengths in the range of about 1 to 7 mm, and a binder.

31. The filter as set forth in claim 30 wherein the first and second active layers are vacuum deposited.

32. The filter as set forth in claim 30 wherein the fibers in the first active layer comprise glass fibers.

33. The filter as set forth in claim 32 wherein the glass fibers have diameters in the range of about 0.6 to 2.6 μm.

34. The filter as set forth in claim 33 wherein the glass fibers have a length in the range of about 0.3 to 0.5 mm.

35. The filter as set forth in claim 31 including a post-filtration layer vacuum deposited on the core before the first active layer from an aqueous slurry of fibers having a fiber diameter of not less than about 5 μm and a binder.

36. The filter as set forth in claim 35 wherein the post-filtration layer fibers are selected from the group consisting of synthetics and cellulose.

37. The filter as set forth in claim 36 wherein the post-filtration layer binder comprises a polyolefin.

38. The filter as set forth in claim 32 wherein the first active layer fibers include fibers selected from the group consisting of synthetics and cellulose.

39. The filter as set forth in claim 38 wherein the first active layer binder comprises a polyolefin.

40. The filter as set forth in claim 30 wherein the second active layer fibers are selected from the group consisting of synthetics and cellulose.

41. The filter as set forth in claim 40 wherein the second active layer binder comprises a polyolefin.

42. The filter as set forth in claim 30 wherein the second active fiber layer includes a powdered adsorbent.

43. The filter as set forth in claim 42 wherein the adsorbent comprises activated carbon.

44. The filter as set forth in claim 42 wherein the adsorbent is effective for the removal of heavy metals.

45. A long life, low pressure drop, cyst reduction water filter comprising:
a rigid foraminous cylindrical core;
a post-filtration layer vacuum deposited on the core from an aqueous slurry of synthetic fibers having nominal diameters in the range of about 5 to 40 μm and a binder;
a first active layer vacuum deposited on the post-filtration layer from an aqueous slurry of fibers selected from the group consisting of glass and synthetics, and having nominal diameters in the range of about 0.5 to 5 μm and a binder; and,
a second active layer vacuum deposited on the first active layer from an aqueous slurry of synthetic fibers having nominal diameters in the range of about 5 to 30 μm, carbon particles, and a binder.

46. The filter as set forth in claim 45 wherein the first active layer fibers having a length in the range of about 0.5 to 1.0 mm.

47. The filter as set forth in claim 45 wherein the second active layer fibers have lengths in the range of about 1 to 7 mm.

48. The filter as set forth in claim 45 wherein the first active layer glass fibers comprise about 25% fibers having a diameter of 2.6 μm and about 75% fibers having a diameter of 0.6 μm.

49. The filter as set forth in claim 45 wherein the post-filtration layer fibers have lengths in the range of about 1 to 7 mm.
